(19) United States
(12) Patent Application Publication
(10) Pub. No.: US 2023/0243948 A1
(43) Pub. Date: Aug. 3, 2023

(54) SCANNING NONLINEAR JUNCTION DETECTION METHOD AND DEVICE

(71) Applicant: Shenzhen AWP Technology Co., Ltd., Shenzhen (CN)

(72) Inventor: Tijun Bie, Shenzhen (CN)

(21) Appl. No.: 18/132,990

(22) Filed: Apr. 11, 2023

Related U.S. Application Data
(63) Continuation of application No. PCT/CN2020/121118, filed on Oct. 15, 2020.

(51) Int. Cl. G01S 13/04; G01S 13/42

(52) U.S. Cl. CPC G01S 13/04; G01S 13/426; G01S 2013/0245

(57) ABSTRACT

The present invention discloses a scanning nonlinear junction detection method and device. The method comprises following steps: S1. dividing a detection region into multiple sub-regions, transmitting signals to all the sub-regions one by one; S2. receiving signals fed back from the sub-regions, obtaining amplitude of harmonic components measured from all the sub-regions according to the signals fed back; if a harmonic component of a certain sub-region exceeds a preset value, determining that a nonlinear junction is present in the sub-region. The device comprises a transmission unit, a reception unit, a detection signal control unit, a reception data processing unit, and a control and display unit. In the present invention, an accurate position and direction in which the nonlinear junction is located are quickly determined, an occurrence of missing scanning is avoided, and speed and efficiency of searching for the nonlinear junction are improved.

### CROSS REFERENCE TO RELATED APPLICATIONS

The present application is a Continuation Application of PCT Application No. PCT/CN2020/121118 filed on Oct. 15, 2020, the contents of which are incorporated herein by reference in their entirety.

### FIELD OF INVENTION

The present invention belongs to the technical field of nonlinear junction detection, and particularly relates to a scanning nonlinear junction detection method and device.

### BACKGROUND ART OF THE INVENTION

A nonlinear junction includes a semiconductor junction and a metal-metal oxide junction. Such junction has a characteristic that a relationship between voltage and current is nonlinear, so when an input signal is a high-frequency sinusoidal signal, a harmonic signal of the input signal may be generated at the nonlinear junction. A nonlinear junction detector detects apparatus containing semiconductor junctions and metal-to-metal oxide junctions by means of harmonic properties of the nonlinear junction detector, and is usually used to search for detectaphone, camera and other hidden electronic apparatus.

An existing nonlinear junction detector includes a transmission unit (TX) and a reception unit (RX). A detection signal is transmitted by an antenna, if a nonlinear junction is present within a coverage range of the antenna, a harmonic signal is generated and is received by the RX unit, according to a signal intensity of the received harmonic signal, it is indicated whether a nonlinear junction is present in a region under detection. This method is used to search for hidden electronic products (eavesdropping devices in general).

When used in practice, the existing nonlinear junction detector needs to search for the region under detection by scanning back and forth to find hidden nonlinear junctions. For a region with a large area, scanning search takes more time, and has a risk of missing scanning.

### Disclosure of the Invention

To solve the problem and defect existing in the prior art, a purpose of the present invention is to provide a scanning nonlinear junction detection method and device which can quickly point out a region and position in which a nonlinear junction is located in a detection region.

To achieve the above purpose, the present invention provides a scanning nonlinear junction detection method, used to detect electronic apparatus containing nonlinear junctions, comprising following steps:

S1. dividing a detection region into multiple sub-regions, transmitting, by a transmission unit, signals to all the sub-regions one by one;

S2. receiving, by a reception unit, signals fed back from the sub-regions, obtaining amplitude of harmonic components measured from all the sub-regions according to the signals fed back; if a harmonic component of a certain sub-region exceeds a preset value, determining that a nonlinear junction is present in the sub-region.

Further, in step S1, the sub-regions are arranged in m rows and n columns, where m>1, n>1.

Further, an effective space angle of the transmission unit includes a horizontal angle θ, a pitch angle φ. A space angle coordinate range of the detection region is (−0.5n*θ to 0.5n*θ, −0.5m*φ to 0.5m*φ).

Further, a space angle coordinate range of each of the sub-regions is [a*θ to (a+1)*θ, (b+1)*φ to b*φ], where −0.5n≤a≤0.5n−1, −m/2≤b≤0.5m−1.

Further, in step S1, the transmission unit is an antenna array including multiple transmission antennas, wherein relationships between electrical signal phases of the transmission antennas are controlled to change a beam angle of the transmission unit, so the transmission unit scans the sub-regions one by one.

Further, the transmission antennas are arranged in multiple rows and multiple columns.

Further, a main lobe direction when the transmission unit scans each of the sub-regions directs to a center point of each of the sub-regions.

Further, the method further comprises step S3: setting the sub-region in which the nonlinear junction is located as a new detection region, and repeating steps S1 and S2, until a precise position of the nonlinear junction is found.

The present invention also provides a scanning nonlinear junction detection device, using the scanning nonlinear junction detection method, comprising:
a transmission unit used to transmit signals to all sub-regions of a detection region;
a reception unit used to receive the signals fed back from the sub-regions;
a detection signal control unit used to control detection signals from the transmission unit;
a reception data processing unit used to obtain amplitude of harmonic components measured from the sub-regions according to the signals fed back; and
a control and display unit used to control and display operating conditions and results of the detection signal control unit and the reception data processing unit.

Further, the transmission unit comprises multiple transmission antennas which are arranged in multiple rows and multiple columns.

Compared with the prior art, the present invention has following advantageous effects: a detection region is divided into multiple sub-regions, each sub-region is scanned by a transmission unit, if amplitude of a harmonic component of a signal fed back from a certain sub-region exceeds a preset value, it is determined that a nonlinear junction is present in the sub-region, so an occurrence of missing scanning is avoided, an accurate position and region in which the nonlinear junction is located are quickly found, and speed and efficiency of searching for the nonlinear junction are improved.

### DESCRIPTION OF THE DRAWINGS

FIG. 1 is a working schematic diagram 1 of embodiment 2 of the present invention;

FIG. 2 is a method step diagram of embodiment 1 of the present invention;

FIG. 3 is a working schematic diagram 2 of embodiment 1 of the present invention;

FIG. 4 is a working schematic diagram 3 of embodiment 1 of the present invention;

FIG. 5 is a structural diagram showing main lobe directions of an antenna array in embodiment 1 of the present invention;

FIG. 6 is an antenna array arrangement diagram 1 of embodiment 1 of the present invention;

FIG. 7 is an antenna array arrangement diagram 2 of embodiment 1 of the present invention;

FIG. 8 is a frame connection diagram of embodiment 2 of the present invention;

FIG. 9 is a circuit connection diagram 1 of embodiment 2 of the present invention;

FIG. 10 is a circuit connection diagram 2 of embodiment 2 of the present invention.

### DETAILED DESCRIPTION OF THE INVENTION

To make the purpose, the technical solution and the advantages of the present invention more clear, the present invention will be further described below in detail in combination with the drawings and the embodiments. It should be understood that the specific embodiments described herein are only used for explaining the present invention, not used for limiting the present invention.

### Embodiment 1

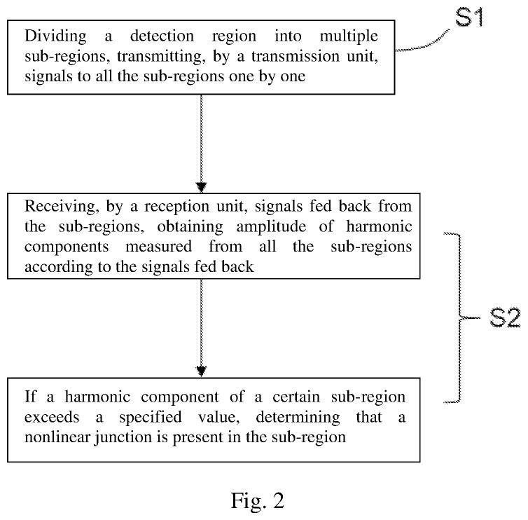

Embodiment 1 of the present invention provides a scanning nonlinear junction detection method, used to detect electronic apparatus containing nonlinear junctions, as shown in FIG. 2, comprising following steps:

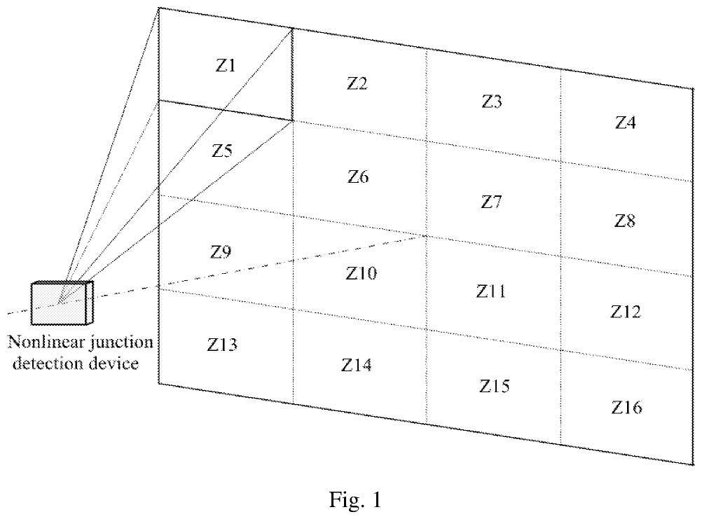

S1. as shown in FIG. 1, dividing a detection region into multiple sub-regions, transmitting, by a transmission unit, signals to all the sub-regions one by one;

S2. receiving, by a reception unit, signals fed back from the sub-regions, obtaining amplitude of harmonic components measured from all the sub-regions according to the signals fed back; if a harmonic component of a certain sub-region exceeds a preset value, determining that a nonlinear junction is present in the sub-region.

By means of the method, a detection region is divided into multiple sub-regions, each sub-region is scanned by a transmission unit, if amplitude of a harmonic component of a signal fed back from a certain sub-region exceeds a preset value, it is determined that a nonlinear junction is present in the sub-region, in this way, a detection region of a nonlinear junction is greatly reduced, an occurrence of missing scanning is avoided, a position and region in which the nonlinear junction is located are quickly found, and speed and efficiency of searching for the nonlinear junction are improved.

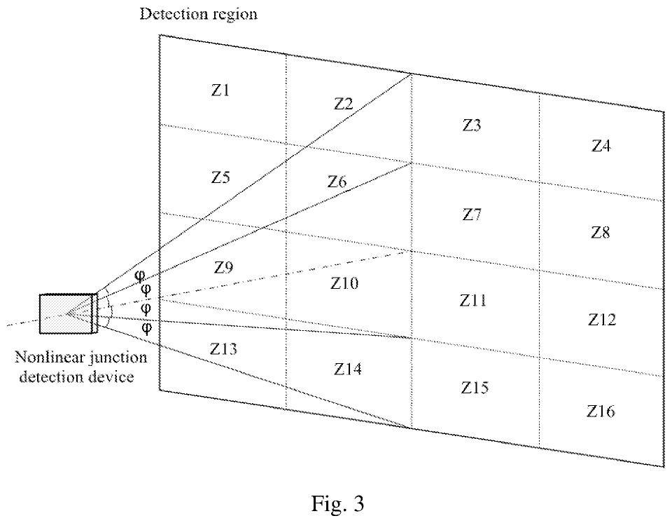

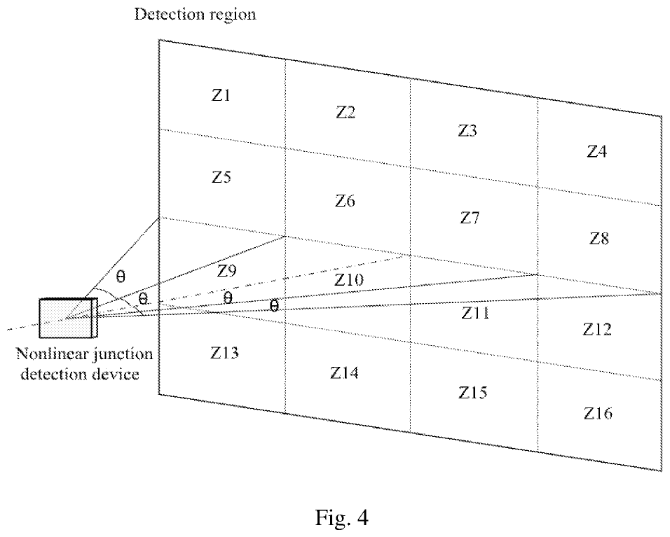

In step S1, the sub-regions are arranged in m rows and n columns, where m>1, n>1. As shown in FIG. 3 and FIG. 4, an effective space angle of the transmission unit includes a horizontal angle θ, a pitch angle φ; a space angle coordinate range of the detection region is (−0.5n*θ to 0.5n*θ, −0.5m*φ to 0.5m*φ). A space angle coordinate range of each of the sub-regions is [a*θ to (a+1)*θ, (b+1)*φ to b*φ], where −0.5n≤a≤0.5n−1, −m/2≤b≤0.5m−1.

Both m and n may be integers greater than 1. In this embodiment, in is preferably 4, n is preferably 4. In this way, sixteen sub-regions are respectively represented by Z1-Z16. A space angle coordinate range of the detection region is (−2θ to 2θ, −2φ to 2φ). Space angle coordinates of all sub-regions are allocated as follows:

### Z1 31 2θ to −θ, 2φ to φ); Z2 (−θ to 0, 2φ to φ);

### Z3 (0 to θ, 2φ to φ); Z4 (θ to 2φ to φ);

### Z5 (−2θ to −θ, −θ to 0); Z6 (−θ to 0, φ to 0);

### Z7 (0 to θ, φ to 0); Z8 (θ to 2θ, φ to 0);

### Z9 (−2θ to −θ, 0 to −φ); Z10 (−θ to 0, 0 to −φ);

### Z11 (0 to θ, 0 to −φ); Z12 (θto 2θ, 0 to −φ);

### Z13 (−2θ to −θ, −φ to −2φ); Z14 (−θto 0, −φ to −2φ);

### Z15 (0 to θ, −φ to −2φ); Z16 (θ to 2θ, −φ to −2φ).

In step S1, the transmission unit is an antenna array including multiple transmission antennas, wherein relationships between electrical signal phases of the transmission antennas are controlled to change a beam angle of the transmission unit, so the transmission unit scans the sub-regions one by one. Designated phase combinations are set, so beams of the antenna array are divided according to corresponding detection regions, and then all sub-regions are scanned one by one. It should be noted that how to change a beam angle of the transmission unit by controlling relationships between electrical signal phases of the transmission antennas is a widely known technical means for those skilled in the art. This technical means also has many applications in radar detection and other technical fields.

The transmission antennas are arranged in multiple rows and multiple columns, so a control accuracy of the beam angle of the transmission unit may be improved.

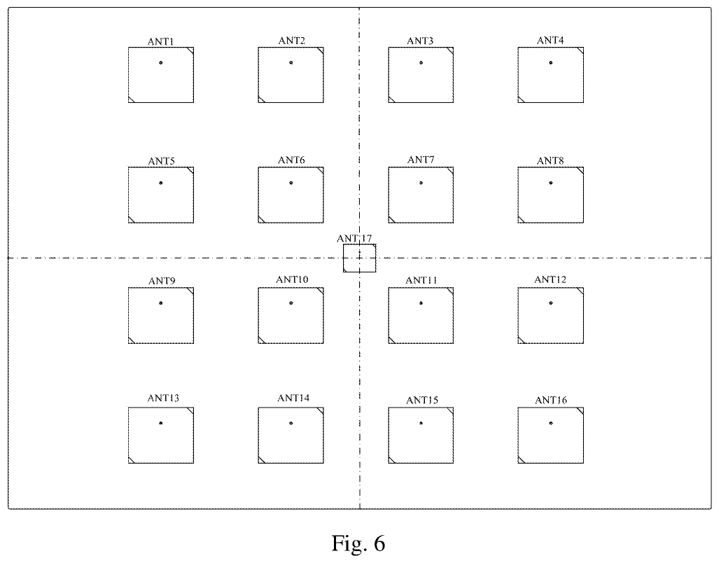

In this embodiment, arrangement of the antenna array is shown in FIG. 6, an antenna array with 4×4 antennas is used, the antennas being fixed to a same plane, where ANT1-ANT16 represent transmission antennas, distances between two adjacent antennas are equal in both horizontal and vertical dimensions, the transmission antennas operate at a fundamental frequency; ANT17 represents a reception unit which operates at a harmonic frequency, and a beam angle of the reception unit covers the whole detection region.

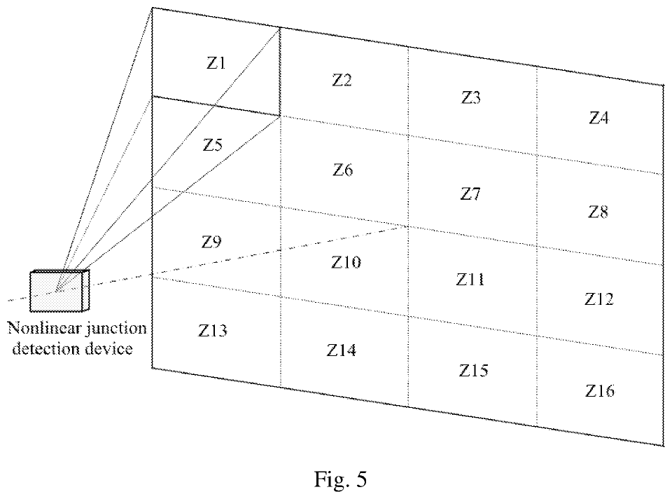

As shown in FIG. 5, a main lobe direction when the transmission unit scans each of the sub-regions directs to a center point of each of the sub-regions.

In this embodiment, main lobe directions when the transmission unit scans all the sub-regions are as follows:

Z1, main lobe direction (−1.50, 1.5φ); Z2, main lobe direction (−0.50, 1.5φ);
Z3, main lobe direction (0.50, 1.5φ); Z4, main lobe direction (1.50, 1.5φ);
Z5, main lobe direction (−1.50, 0.5φ); Z6, main lobe direction (−0.50, 0.5φ);
Z7, main lobe direction (0.50, 0.5φ); Z8, main lobe direction (1.50, 0.5φ);
Z9, main lobe direction (−1.50, −0.5φ); Z10, main lobe direction (−0.50, −0.5φ);
Z11, main lobe direction (0.50, −0.5φ); Z12, main lobe direction (1.50, −0.5φ);
Z13, main lobe direction (−1.50, −1.5φ); Z14, main lobe direction (−0.50, −1.5φ);
Z15, main lobe direction (−0.50, −1.5φ); Z16, main lobe direction (1.50, −1.5φ);

The antenna array with 4×4 antennas may accurately control a direction of the beam angle, accurately scan each sub-region, and improve detection accuracy.

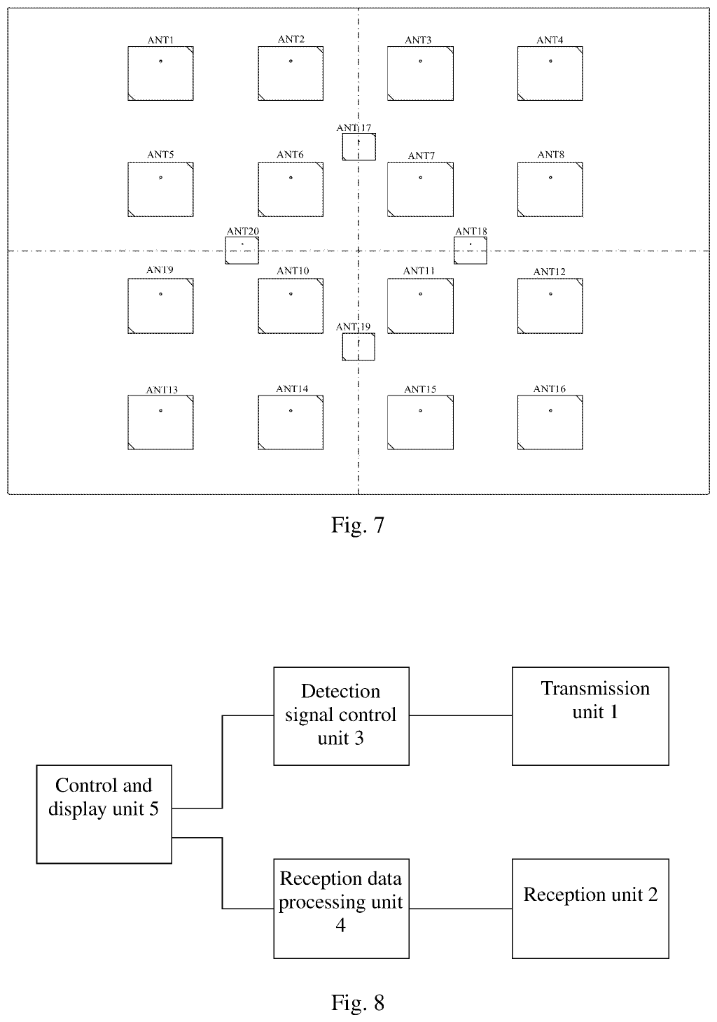

In this embodiment, as shown in FIG. 7, the reception unit may include multiple reception antennas, ANT17-ANT20 represent reception antennas which operate at a harmonic frequency, and beam angles of the reception antennas cover the whole detection region. The reception antennas are arranged in a cross vertically and horizontally. An incident direction of a harmonic signal may be tested by a phase method (this method is stated in the invention with an application No. 202010694283X, and is not repeated here because of not belonging to the protection range required by the present invention).

Further, this embodiment further comprises step S3: setting the sub-region in which the nonlinear junction is located as a new detection region, and repeating steps S1 and S2, until a precise position of the nonlinear junction is found. In this way, detection accuracy and speed of the nonlinear junction may be further improved.

The specific method steps of this embodiment are as follows:

first, dividing a detection region into 4×4 sub-regions; setting designated phase combinations, so beams of an antenna array are divided according to corresponding detection regions, and then transmitting, by all transmission antennas of a transmission unit, detection signals to all the sub-regions one by one to conduct scanning detection;

then, receiving, by a reception unit, signals fed back from the sub-regions, obtaining amplitude of harmonic components measured from all the sub-regions according to the signals fed back; if a harmonic component of a certain sub-region exceeds a preset value, determining that a nonlinear junction is present in the sub-region;

further reducing the detection region, setting the sub-region in which the nonlinear junction is located as a new detection region, and repeating steps S1 and S2, until a precise position of the nonlinear junction is found.

### Embodiment 2

Embodiment 2 of the present invention provides a scanning nonlinear junction detection device, using the scanning nonlinear junction detection method provided in embodiment 1, as shown in FIG. 8, comprising:

a transmission unit 1 used to transmit signals to all sub-regions of a detection region;

a reception unit 2 used to receive the signals fed back from the sub-regions;

a detection signal control unit 3 used to control detection signals from the transmission unit 1;

a reception data processing unit 4 used to obtain amplitude of harmonic components measured from the sub-regions according to the signals fed back; and

a control and display unit 5 used to control and display operating conditions and results of the detection signal control unit and the reception data processing unit 4.

By means of the above structure, the detection signal control unit controls the transmission unit 1 to transmit detection signals to all the sub-regions of the detection region, the reception unit 2 receives the signals fed back from the sub-regions and transmits same to the reception data processing unit 4, the reception data processing unit 4 obtains amplitude of harmonic components measured from the sub-regions according to the signals fed back; the control and display unit 5 controls and displays operating conditions and results of the detection signal control unit 3 and the reception data processing unit 4, so if a harmonic component of a certain sub-region exceeds a preset value, it is determined that a nonlinear junction is present in the sub-region. In this way, a positions and region in which the nonlinear junction is located are quickly found, and speed and efficiency of searching for the nonlinear junction are improved.

In this embodiment, the transmission unit 1 comprises multiple transmission antennas which are arranged in multiple rows and multiple columns, preferably, four rows and four columns.

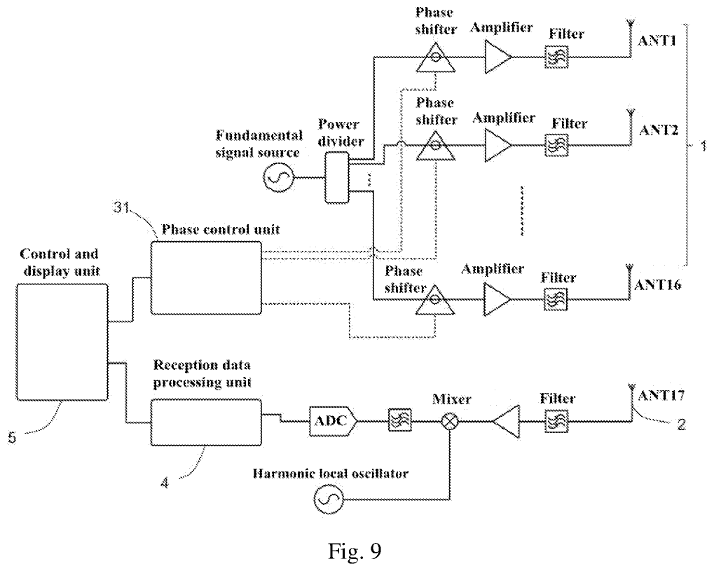

If the reception unit 2 includes a single reception antenna, as shown in FIG. 9, the detection signal control unit 3 comprises a phase control unit 31 used to control transmission signal phases, ANT1-ANT16 represent the transmission antennas, and ANT17 represents the reception antenna. Detection signals are generated by a fundamental signal source, equally divided into 16 paths of signals by a power divider, and transmitted by the transmission antennas after passing through phase shifters, amplifiers and filters. When a transmission signal circuit is designed, it is guaranteed that electrical lengths of various signal pathways are equal, gains are equal, and a phase adjustment range of the phase shifters is 0-360 d °.

A reception signal circuit adopts a universal superheterodyne receiver scheme. A harmonic signal received by the reception antenna is converted into an intermediate-frequency signal after passing through a filter, an amplifier and a mixer, digitalized by ADC, and then calculated by the reception data processing unit 4. The superheterodyne receiver scheme is a method for converting an input signal frequency into a certain predetermined frequency by mixing a locally generated oscillation wave with an input signal. The problems of weak output signals and poor stability of an original high-frequency amplifying receiver are effectively solved. Moreover, an output signal has high selectivity and good frequency characteristics and is easy to adjust.

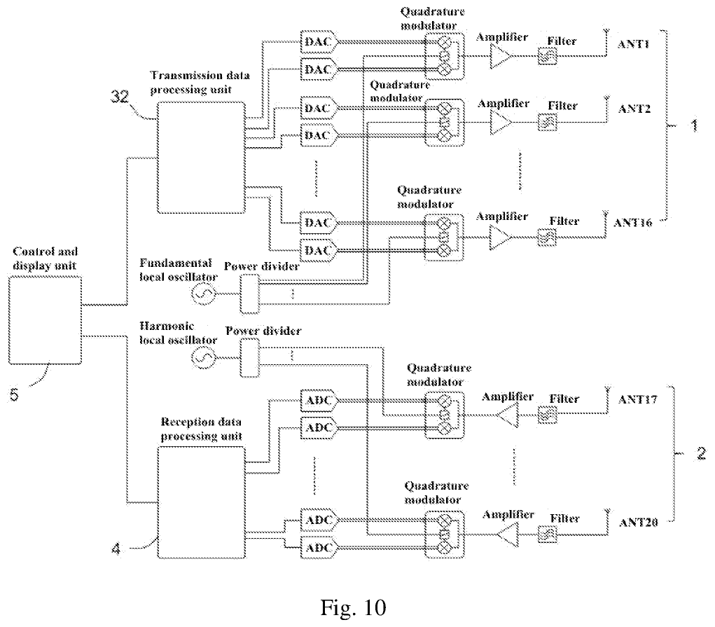

If the reception unit 2 includes multiple reception antennas, for example, four reception antennas, as shown in FIG. 10, the detection signal control unit 3 comprises a transmission data processing unit 32 used to process transmission signals, ANT1-ANT16 represent the transmission antennas, and ANT17-ANT20 represent the reception antennas; The transmission signals are generated from fundamental local oscillator and intermediate-frequency signals through orthogonal modulation. The local oscillator signals come from the fundamental local oscillator and are equally divided by the power dividers, and the intermediate-frequency signals come from 16×2 paths of DAC. Clocks of all the DAC are homologous. The intermediate-frequency signals generated by the DAC are identical in frequency, but are different in phase. Phases are output according to presetting. RF links are transmitted by the transmission antennas after passing through quadrature modulators, amplifiers and filters. When a circuit is designed, it is guaranteed that electrical lengths of various signal pathways are equal, gains are equal.

A reception circuit adopts a complex intermediate-frequency receiver scheme. Harmonic signal received by the reception antennas are converted into intermediate-frequency signals after passing through the filters, the amplifiers and the mixer, digitalized by ADC, and then calculated by the reception data processing unit 4. Four paths of signals may be received simultaneously. Arrival angles of harmonic signals may be calculated according to different phases (this algorithm is stated in the invention with an application No. 202010694283.X, and is not repeated here because of not belonging to the protection range required by the present invention).

It should be noted that both the superheterodyne receiver scheme and the complex intermediate-frequency receiver scheme are conventional technical means in the art, and implementation methods thereof are widely known by those skilled in the art.

The above is just one concrete embodiment of the present invention, but the protection scope of the present invention is not limited thereto. Any change or replacement contemplated easily by those skilled in the art familiar with the technical field within the technical scope disclosed by the present invention shall be covered within the protection scope of the present invention. Therefore, the protection scope of the present invention should be determined by the protection scope of the claims.

What is claimed is:

1. A scanning nonlinear junction detection method, used to detect electronic apparatus containing nonlinear junctions, comprising following steps:
S1. dividing a detection region into multiple sub-regions, transmitting, by a transmission unit, signals to all the sub-regions one by one;
S2. receiving, by a reception unit, signals fed back from the sub-regions, obtaining amplitude of harmonic components measured from all the sub-regions according to the signals fed back; if one of the harmonic components of a certain sub-region exceeds a preset value, determining that a nonlinear junction is present in the sub-region.

2. The scanning nonlinear junction detection method according to claim 1, characterized in that in step S1, the sub-regions are arranged in m rows and n columns, where m>1, n>1.

3. The scanning nonlinear junction detection method according to claim 2, characterized in that an effective space angle of the transmission unit includes a horizontal angle θ, a pitch angle φ; a space angle coordinate range of the detection region is (−0.5n*θ to 0.5n*θ, −0.5m*φ to 0.5m*φ).

4. The scanning nonlinear junction detection method according to claim 3, characterized in that a space angle coordinate range of each of the sub-regions is [a*θ to (a+1)*θ, (b+1)*φ to b*φ], where −0.5n≤a≤0.5n−1, −m/2≤b≤0.5m−1.

5. The scanning nonlinear junction detection method according to claim 1, characterized in that in step S1, the transmission unit is an antenna array including multiple transmission antennas, wherein relationships between electrical signal phases of the transmission antennas are controlled to change a beam angle of the transmission unit, so the transmission unit scans the sub-regions one by one.

6. The scanning nonlinear junction detection method according to claim 2, characterized in that in step S1, the transmission unit is an antenna array including multiple transmission antennas, wherein relationships between electrical signal phases of the transmission antennas are controlled to change a beam angle of the transmission unit, so the transmission unit scans the sub-regions one by one.

7. The scanning nonlinear junction detection method according to claim 3, characterized in that in step S1, the transmission unit is an antenna array including multiple transmission antennas, wherein relationships between electrical signal phases of the transmission antennas are controlled to change a beam angle of the transmission unit, so the transmission unit scans the sub-regions one by one.

8. The scanning nonlinear junction detection method according to claim 4, characterized in that in step S1, the transmission unit is an antenna array including multiple transmission antennas, wherein relationships between electrical signal phases of the transmission antennas are controlled to change a beam angle of the transmission unit, so the transmission unit scans the sub-regions one by one.

9. The scanning nonlinear junction detection method according to claim 5, characterized in that the transmission antennas are arranged in multiple rows and multiple columns.

10. The scanning nonlinear junction detection method according to claim 6, characterized in that the transmission antennas are arranged in multiple rows and multiple columns.

11. The scanning nonlinear junction detection method according to claim 7, characterized in that the transmission antennas are arranged in multiple rows and multiple columns.

12. The scanning nonlinear junction detection method according to claim 8, characterized in that the transmission antennas are arranged in multiple rows and multiple columns.

13. The scanning nonlinear junction detection method according to claim 9, characterized in that a main lobe direction when the transmission unit scans each of the sub-regions directs to a center point of each of the sub-regions.

14. The scanning nonlinear junction detection method according to claim 10, characterized in that a main lobe direction when the transmission unit scans each of the sub-regions directs to a center point of each of the sub-regions.

15. The scanning nonlinear junction detection method according to claim 11, characterized in that a main lobe direction when the transmission unit scans each of the sub-regions directs to a center point of each of the sub-regions.

16. The scanning nonlinear junction detection method according to claim 12, characterized in that a main lobe direction when the transmission unit scans each of the sub-regions directs to a center point of each of the sub-regions.

17. The scanning nonlinear junction detection method according to claim 1, further comprising step S3: setting the sub-region in which the nonlinear junction is located as a new detection region, and repeating steps S1 and S2, until a precise position of the nonlinear junction is found.

18. A scanning nonlinear junction detection device, comprising: a transmission unit (1) used to transmit detection signals to all sub-regions of a detection region, a reception unit (2) used to receive signals fed back from the sub-regions, a detection signal control unit (3) used to control detection signals from the transmission unit (1), a reception data processing unit (4) used to obtain amplitude of harmonic components obtained from the sub-regions according to the signals fed back, and a control and display unit (5) used to control and display operating conditions and results of the detection signal control unit (3) and the reception data processing unit (5).

19. The scanning nonlinear junction detection device according to claim 18, characterized in that the transmission unit (1) comprises multiple transmission antennas which are arranged in multiple rows and multiple columns.
